(19) United States
(12) Patent Application Publication
(10) Pub. No.: US 2017/0232836 A1
(43) Pub. Date: Aug. 17, 2017

(54) FILLER PIPE AND VEHICLE FUEL FILLER PORT STRUCTURE

(71) Applicants: TOYOTA JIDOSHA KABUSHIKI KAISHA, Toyota-shi (JP); TOYODA GOSEI CO., LTD., Kiyosu-shi (JP)

(72) Inventors: Motoyasu KITO, Aichi-gun (JP); Hiroyuki YAMADA, Toyota-shi (JP); Shinji SHIMOKAWA, Seto-shi (JP); Atsushi SEKIHARA, Kiyosu-shi (JP); Yoshinari HIRAMATSU, Kiyosu-shi (JP)

(73) Assignees: TOYOTA JIDOSHA KABUSHIKI KAISHA, Toyota-shi (JP); TOYODA GOSEI CO., LTD., Kiyosu-shi (JP)

(21) Appl. No.: 15/430,780

(22) Filed: Feb. 13, 2017

(30) Foreign Application Priority Data
Feb. 16, 2016 (JP) 2016-026767

(51) Int. Cl. B60K 15/04

(52) U.S. Cl. CPC B60K 15/04; B60K 2015/0458

(57) ABSTRACT

A retainer that holds a fuel nozzle holder is mounted to a filler pipe. The retainer includes: a first attaching portion mounted at the filler pipe; an opening located at a first end of the retainer, which is closer to a center of the filler pipe than a second end; and a holding portion having engaging holes. The fuel nozzle holder includes: a second attaching portion having a cylindrical shape and including two engaging pieces engaged in the engaging holes and located on opposite sides in a circumference of the second attaching portion. The engaging pieces are each surrounded by a groove at three sides and joined to the second attaching portion on one, and the two engaging pieces are different from each other in terms of a maximum value of a length in a circumferential direction of the second attaching portion.

### INCORPORATION BY REFERENCE

The disclosure of Japanese Patent Application No. 2016-026767 filed on Feb. 16, 2016 including the specification, drawings and abstract is incorporated herein by reference in its entirety.

### BACKGROUND

1. Technical Field

The present disclosure relates to a filler pipe and a vehicle fuel filler port structure.

2. Description of Related Art

As shown in FIG. 14, a filler pipe main body 110 is mounted to inject fuel into an automotive fuel tank from a vehicle body fueling port provided in a vehicle body. To inject fuel, a distal end portion 141 of a fuel nozzle 140 is inserted into an injection port 111 of the filler pipe main body 110.

A structure is known in which, to hold the fuel nozzle 140 and stabilize the fuel flow during this injection, a retainer 120 is provided inside an inlet part 112 of the filler pipe main body 110 and a leading end portion of the retainer 120 is elongated into a pipe-like shape (e.g., see Japanese Patent Application Publication No. 2014-104919). In this case, the distal end portion 141 of the fuel nozzle 140 is held by the leading end portion of the retainer 120 so that the distal end portion 141 of the fuel nozzle 140 always faces the same direction.

Another structure is known in which, as shown in FIG. 15, a retainer 220 and a fuel nozzle holder 230 that holds a distal end portion of a fuel nozzle are mounted at an inlet part 212 of a filler pipe main body 210 (e.g., see JP 2014-104919 A). An engaging claw 231 is formed in the fuel nozzle holder 230, and the engaging claw 231 is engaged with an engaging claw 213 formed in the inlet part 212 of the filler pipe main body 210.

Still another structure is known in which, as shown in FIG. 16 to FIG. 18, a retainer 320 is mounted at an inlet part 312 of a filler pipe main body 310 and a fuel nozzle holder 330 is mounted in the retainer 320. In this case, a attaching portion 332 of the fuel nozzle holder 330 is engaged with a holding portion 326 of the retainer 320, and the attaching portion 332 comes in contact with an inner surface of the retainer 320 to seal the clearance.

Specifically, engaging holes 326a are formed on the opposite sides in the circumference of the holding portion 326 of the retainer 320, while engaging pieces 332b are formed on the opposite sides in the circumference of the attaching portion 332 of the fuel nozzle holder 330 so as to correspond to the engaging holes 326a. A groove 332d is formed along the three sides of each engaging piece 332b. The engaging pieces 332b are engaged in the engaging holes 326a.

### SUMMARY

In the structure of the fueling port shown in FIG. 14, the retainer 120 is formed by a separate part and the leading end portion of the retainer 120 is elongated into a pipe-like shape, so that, contrary to requirements for reduction in vehicle body weight, the weight of the retainer 120 as a whole increases. Moreover, to hold the distal end portion 141 of the fuel nozzle 140, the leading end portion of the retainer 120 is required to have a pipe diameter that is substantially equal to the nozzle diameter of the distal end portion 141 of the fuel nozzle 140, which makes it troublesome to insert or extract the distal end portion 141 of the fuel nozzle 140.

If the leading end portion of the retainer 120 is not elongated, the distal end portion 141 of the fuel nozzle 140 can be inserted until coming in contact with the filler pipe main body 110. Thus, the position of the distal end portion 141 of the fuel nozzle 140 varies significantly inside the filler pipe main body 110, so that the fuel flow is adversely affected, or an automatic stop sensor of the fuel nozzle 140 is activated during fueling due to a backflow of the fuel, resulting in reduced fueling efficiency.

Moreover, if the fuel nozzle 140 is inserted too deep into the filler pipe main body 110, the fuel nozzle 140 may become difficult to extract by being caught between the filler pipe main body 110 and the retainer 120. In addition, if the fuel nozzle 140 is inserted too deep into the filler pipe main body 110, the main body of the fuel nozzle 140 and the vehicle body may interfere with each other.

In the structure shown in FIG. 15 to FIG. 18, the widths (indicated by X and Y in FIG. 17A and FIG. 17B) in the circumferential direction of the engaging pieces 332b formed on both sides are the same. Thus, the fuel nozzle holder 330 may be incorrectly mounted to the retainer 320 with the left and right sides reversed. If the fuel nozzle holder 330 is installed incorrectly, as shown in FIG. 18, the central axis of the fuel nozzle holder 330 is misaligned and a distal end portion 333 interferes with the inner surface of the filler pipe 310, disturbing the fuel flow from the fuel nozzle.

The present disclosure provides a filler pipe and a structure of a vehicle fueling port that can prevent incorrect installation of a fuel nozzle holder.

The first aspect of the disclosure provides a filler pipe in which a retainer that holds a fuel nozzle holder is mounted. In the first aspect, the retainer includes: a first attaching portion mounted at an inlet part of the filler pipe; an opening located at a first end of the retainer, the first end being closer to a center of the filler pipe in a longitudinal direction than a second end of the retainer; and a holding portion having engaging holes, the fuel nozzle holder includes: a second attaching portion having a cylindrical shape and mounted to the retainer, the second attaching portion includes two engaging pieces; and a main body extending from the second attaching portion toward the center of the filler pipe in the longitudinal direction of the filler pipe, the two engaging pieces are located on opposite sides in a circumference of the second attaching portion, the engaging pieces are each surrounded by a U-shaped groove at three sides and joined to the second attaching portion at a connecting portion located on a main body side, and the two engaging pieces are different from each other in terms of a maximum value of a length in a circumferential direction of the second attaching portion, and the fuel nozzle holder is fixed to the retainer by the engaging pieces are engaged in the engaging holes.

In the first aspect, the retainer is mounted at the inlet part of the filler pipe through which fuel is injected into a fuel tank from a vehicle body fueling port formed in an outer surface of a vehicle body. Thus, when inserting a fuel nozzle into the inlet part of the filler pipe, one can have the distal end portion of the fuel nozzle guided by the retainer and held at a predetermined position inside the filler pipe, so that fuel is reliably injected.

The retainer has the first attaching portion mounted at the inlet part of the filler pipe, the holding portion holding the fuel nozzle holder, and the opening located at the leading end of the retainer. Thus, when the first attaching portion is mounted inside the inlet part of the filler pipe, the fuel nozzle holder is held by the holding portion. As the distal end portion of the fuel nozzle is held at a predetermined position by the fuel nozzle holder, fuel can be discharged in a constant direction. The engaging holes provided in the holding portion allow the fuel nozzle holder to be locked at a predetermined position inside the retainer by engaging the engaging pieces in the engaging holes.

The fuel nozzle holder has the second attaching portion mounted to the retainer, the main body extending from the second attaching portion. The second attaching portion comes in contact with an inner surface of the retainer and holds the fuel nozzle holder inside the retainer. Once the fuel nozzle is inserted through the inlet of the filler pipe into the retainer and the fuel nozzle holder, the fuel nozzle can be held stably with the fuel nozzle holder.

The second attaching portion has a cylindrical shape, and the two engaging pieces protruding outward are formed in the second attaching portion. Thus, the second attaching portion comes in contact with an inner surface of the holding portion and the two engaging pieces engage in the two corresponding engaging holes, so that the fuel nozzle holder is locked at a predetermined position by being engaged on both sides of the retainer.

Since the two engaging pieces are formed on the opposite sides in the circumference of the second attaching portion, the fuel nozzle holder can be engaged in a balanced manner on both sides of the second attaching portion. The engaging pieces are each surrounded by a U-shaped groove at three sides and joined to the second attaching portion at a connecting portion on the main body side. Thus, when the fuel nozzle holder is mounted to the retainer, the engaging pieces can deflect easily around the connecting portions joined to the second attaching portion, which allows the engaging pieces to engage in the engaging holes.

The two opposite engaging pieces are different from each other in terms of the length in the circumferential direction. Thus, when inserting the fuel nozzle holder into the retainer, one can correctly engage the two engaging pieces of the fuel nozzle holder in the two corresponding engaging holes. As a result, the fuel nozzle holder is mounted with the central axis thereof coinciding with the central axis of the filler pipe, so that the fuel nozzle holder does not interfere with the filler pipe.

The fuel nozzle holder is fixed to the retainer as the engaging pieces are engaged in the engaging holes. Thus, it is possible to mount the fuel nozzle holder at a predetermined position inside the retainer simply by inserting the fuel nozzle holder into the retainer. It is also possible to remove the fuel nozzle holder from the retainer for repair etc.

In the first aspect, the engaging pieces may be different from each other in terms of a length in the circumferential direction at a leading end located on a side opposite to the main body in a longitudinal direction of the fuel nozzle holder, and the engaging pieces may be the same in terms of a length of the connecting portion in the circumferential direction.

In the above aspect, one engaging piece is longer than the other engaging piece in the circumferential direction at the leading end located on the side opposite to the main body, while the two engaging pieces are the same in terms of the length in the circumferential direction of the connecting portion at which the engaging piece is joined to the attaching portion of the holding member. Thus, when inserting the fuel nozzle holder into the retainer, one can correctly engage the two engaging pieces of the fuel nozzle holder in the corresponding engaging holes. Moreover, this insertion is made easy as the connecting portions have the same length and thus the same deflection load can be exerted on the two engaging pieces.

In the above aspect, the connecting portion of one engaging piece joined to the second attaching portion may have a notch or a through-hole, and may be the same as the connecting portion of the other engaging piece in terms of the length in the circumferential direction.

In the above aspect, one engaging piece is longer than the other engaging piece in the circumferential direction at the leading end located on the side opposite to the main body. The connecting portion of the one engaging piece joined to the second attaching portion has a notch or a through-hole, and is the same as the connecting portion of the other engaging piece in terms of the length in the circumferential direction. Thus, when inserting the fuel nozzle holder into the retainer, one can correctly engage the two engaging pieces of the fuel nozzle holder in the two corresponding engaging holes. Moreover, this insertion is made easy as the connecting portions have the same length and thus the same deflection load can be exerted on the two engaging pieces.

In the first aspect, the engaging pieces may be different from each other in terms of a length in the circumferential direction at a leading end located on a side opposite to the main body in a longitudinal direction of the fuel nozzle holder, and one engaging piece of the engaging pieces that is longer in the circumferential direction may be longer in the longitudinal direction of the fuel nozzle holder than the other engaging piece that is shorter in the circumferential direction.

In the above aspect, one engaging piece is longer than the other engaging piece in the circumferential direction at the leading end located on the side opposite to the main body, and the one engaging piece of the two engaging pieces that is longer in the circumferential direction is longer in the longitudinal direction from the connecting portion to the leading end than the other engaging piece that is shorter in the circumferential direction. Thus, when inserting the fuel nozzle holder into the retainer, one can correctly engage the engaging pieces of the fuel nozzle holder in the corresponding engaging holes. Moreover, this insertion is made easy as the same deflection load can be exerted on the two engaging pieces.

In the first aspect, the engaging pieces may be different from each other in terms of a length in the circumferential direction at a leading end located on a side opposite to the main body in a longitudinal direction of the fuel nozzle holder, and one engaging piece of the engaging pieces that is longer in the circumferential direction may be thicker in a radial direction of the second attaching portion than the other engaging piece.

In the above aspect, one engaging piece is longer than the other engaging piece in the circumferential direction at the leading end located on the side opposite to the main body, and the one engaging piece of the two engaging pieces that is longer in the circumferential direction is thicker than the other engaging piece that is shorter in the circumferential direction. Thus, when inserting the fuel nozzle holder into the retainer, one can correctly engage the engaging pieces of the fuel nozzle holder in the corresponding engaging holes. Moreover, this insertion is made easy as the same deflection load can be exerted on the two engaging pieces.

In the first aspect, the engaging pieces each may have a protrusion that has a longer side along the circumferential direction as seen from a radial direction of the second attaching portion and protrudes toward an outer periphery of the second attaching portion.

In the above aspect, the engaging pieces each have the protrusion that extends in the circumferential direction and protrudes toward the outer periphery of the second attaching portion. Thus, the engaging pieces can be firmly engaged in the engaging holes as the protrusions are reliably locked in the engaging holes.

In the first aspect, the fuel nozzle holder may include a distal end portion in the main body on the side closer to the center of the filler pipe in the longitudinal direction and may hold a distal end portion of a fuel nozzle.

In the first aspect, the retainer and the fuel nozzle holder may be made of synthetic resin or metal.

In the above aspect, the retainer and the fuel nozzle holder are made of synthetic resin or metal. The retainer and the fuel nozzle holder made of synthetic resin are easy to manufacture in predetermined shapes, while the retainer and the fuel nozzle holder made of metal have the high rigidity to reliably hold the distal end portion of the fuel nozzle, as well as high durability.

In the first aspect, when the engaging pieces each have a protrusion that has a longer side along the circumferential direction as seen from a radial direction of the second attaching portion and protrudes toward an outer periphery of the second attaching portion, the engaging pieces may be held in the engaging holes as the protrusions are inserted into the engaging holes.

In the above aspect, lengths of the engaging holes in the circumferential direction of the second attaching portion may be equal to lengths of the corresponding protrusions in the circumferential direction of the second attaching portion.

The second aspect of the disclosure provides a filler pipe in which a retainer that holds a fuel nozzle holder is mounted. In the second aspect, the retainer includes: a first attaching portion mounted at an inlet part of the filler pipe; an opening located at a first end of the retainer, the first end being closer to a center of the filler pipe in a longitudinal direction of the filler pipe than a second end of the retainer; and a holding portion having engaging holes, the fuel nozzle holder includes: a second attaching portion having a cylindrical shape and mounted to the retainer; and a main body extending from the second attaching portion toward the center of the filler pipe in the longitudinal direction of the filler pipe, the second attaching portion includes a plurality of engaging pieces, the engaging pieces are disposed so that a figure formed by connecting the engaging pieces adjacent to each other in a circumference of the second attaching portion is point-symmetric with respect to a center of a circle defined by a cross-section of the second attaching portion, the engaging pieces each have a protrusion that protrudes toward an outer periphery of the second attaching portion, the engaging pieces are each joined to the second attaching portion at a connecting portion provided on a main body side and separated from the second attaching portion by a groove at both ends in a circumferential direction of the second attaching portion and at an end located on a side opposite to the main body in the longitudinal direction of the fuel nozzle holder, at least one of the engaging pieces is different from the other engaging pieces in terms of the shape of the protrusion, and the fuel nozzle holder is fixed to the retainer as the protrusions are inserted into the engaging holes.

In the second aspect, a maximum value of a length of one of the protrusions in the circumferential direction of the second attaching portion may be larger than maximum values of lengths of other protrusions in the circumferential direction of the second attaching portion.

In the second aspect, lengths of the engaging holes in the circumferential direction of the second attaching portion may be equal to the lengths of the corresponding protrusions in the circumferential direction of the second attaching portion.

In the second aspect, all the engaging pieces may be the same in terms of a length of the connecting portion in the circumferential direction of the second attaching portion.

The third aspect of the disclosure provides a vehicle fuel filler port structure including: a filler pipe; a retainer including: a first attaching portion mounted at an inlet part of the filler pipe; an opening located at a first end of the retainer, the first end being closer to a center of the filler pipe in a longitudinal direction of the filler pipe than a second end of the retainer; and a holding portion having engaging holes; and a fuel nozzle holder including: a second attaching portion having a cylindrical shape and mounted to the retainer; and a main body extending from the second attaching portion toward the center of the filler pipe in the longitudinal direction of the filler pipe. The second attaching portion includes a plurality of engaging pieces, the engaging pieces are disposed so that a figure formed by connecting the engaging pieces adjacent to each other in a circumference of the second attaching portion is point-symmetric with respect to a center of a circle defined by a cross-section of the second attaching portion, the engaging pieces each have a protrusion that protrudes toward an outer periphery of the second attaching portion, the engaging pieces are each joined to the second attaching portion at a connecting portion provided on a main body side and separated from the second attaching portion by a groove at both ends in a circumferential direction of the second attaching portion and at an end located on a side opposite to the main body, at least one of the engaging pieces is different from the other engaging pieces in terms of the shape of the protrusion, and the fuel nozzle holder is fixed to the retainer as the protrusions are inserted into the engaging holes.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a left side view of a fuel nozzle holder, showing a first embodiment of the present disclosure;

FIG. 2 is a plan view of the fuel nozzle holder, showing the first embodiment of the present disclosure;

FIG. 3 is a right side view of the fuel nozzle holder, showing the first embodiment of the present disclosure;

FIG. 4 is a right side view of a fuel nozzle holder, showing a second embodiment of the present disclosure;

FIG. 5 is a right side view of a fuel nozzle holder, showing a third embodiment of the present disclosure;

FIG. 6 is a right side view of a second attaching portion of a fuel nozzle holder, showing a fourth embodiment of the present disclosure;

FIG. 7A is a left side view of a engaging piece of a fuel nozzle holder, showing a fifth embodiment of the present disclosure;

FIG. 7B is a right side view of a engaging piece of the fuel nozzle holder, showing the fifth embodiment of the present disclosure;

FIG. 8A is a sectional view of a left-side engaging piece of a fuel nozzle holder, showing a sixth embodiment of the present disclosure;

FIG. 8B is a sectional view of a right-side engaging piece of the fuel nozzle holder, showing the sixth embodiment of the present disclosure;

FIG. 9 is a sectional view showing an embodiment of the present disclosure, and showing a state in which a fuel nozzle holder is installed in a filler pipe and a retainer;

FIG. 10 is a sectional view showing the embodiment of the present disclosure, and showing a state in which a fuel nozzle is inserted in the retainer and the fuel nozzle holder;

FIG. 11 is a side view of the retainer, showing the embodiment of the present disclosure;

FIG. 12 is an exploded perspective view showing the embodiment of the present disclosure, and showing a state in which the retainer and the fuel nozzle holder are being installed in the filler pipe.

FIG. 13 is a perspective view, from obliquely above, showing the embodiment of the present disclosure, and showing a state in which the fuel nozzle holder is mounted in the filler pipe and the retainer;

FIG. 14 is a sectional view of a filler pipe of the related art, with a retainer mounted at an inlet part;

FIG. 15 is an exploded sectional view of a filler pipe of the related art, with a retainer mounted at an inlet part;

FIG. 16 is a right side view of a fuel nozzle holder of the related art;

FIG. 17A is one side view of a engaging piece of the fuel nozzle holder of the related art;

FIG. 17B is one side view, different from FIG. 17A, of a engaging piece of the fuel nozzle holder of the related art; and

FIG. 18 is a sectional view showing a state in which the fuel nozzle holder is installed in the filler pipe and the retainer of the related art.

### DETAILED DESCRIPTION OF EMBODIMENTS

In this embodiment, a retainer 20 and a fuel nozzle holder 30 are mounted in a filler pipe 10 through which fuel is injected into an automotive fuel tank from a vehicle body fueling port provided in a vehicle body of an automobile. The filler pipe 10 can be made of synthetic resin or metal. The retainer 20 is mounted at an inlet part 12 of the filler pipe 10.

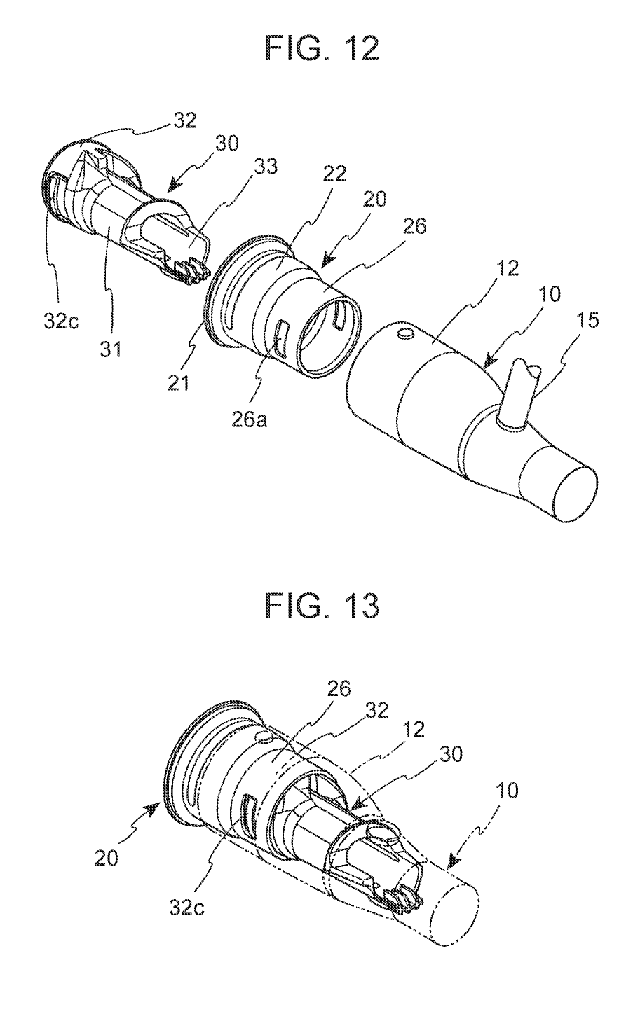

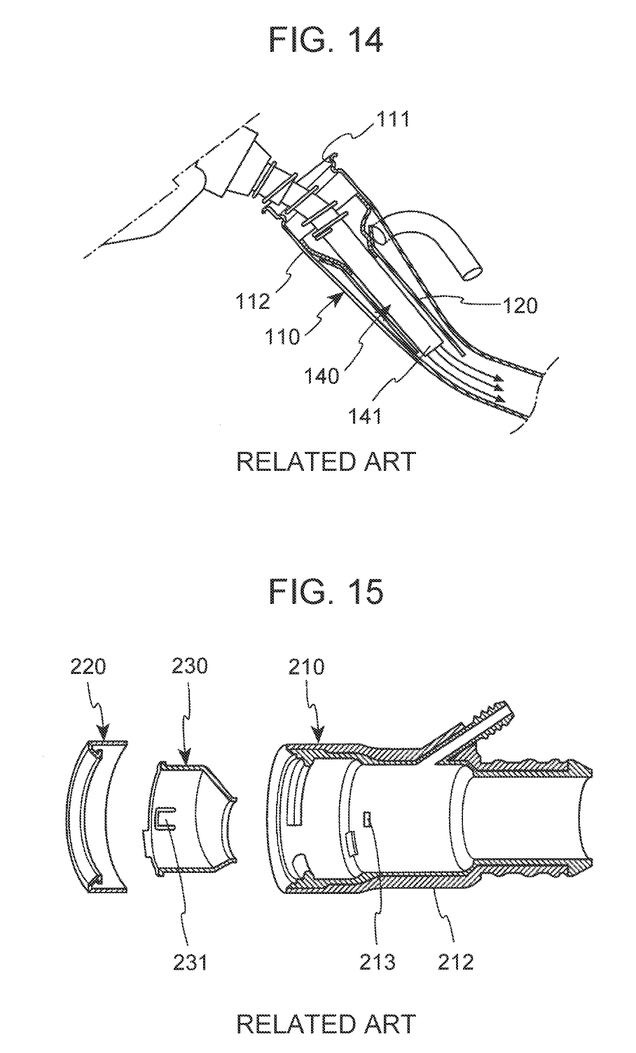

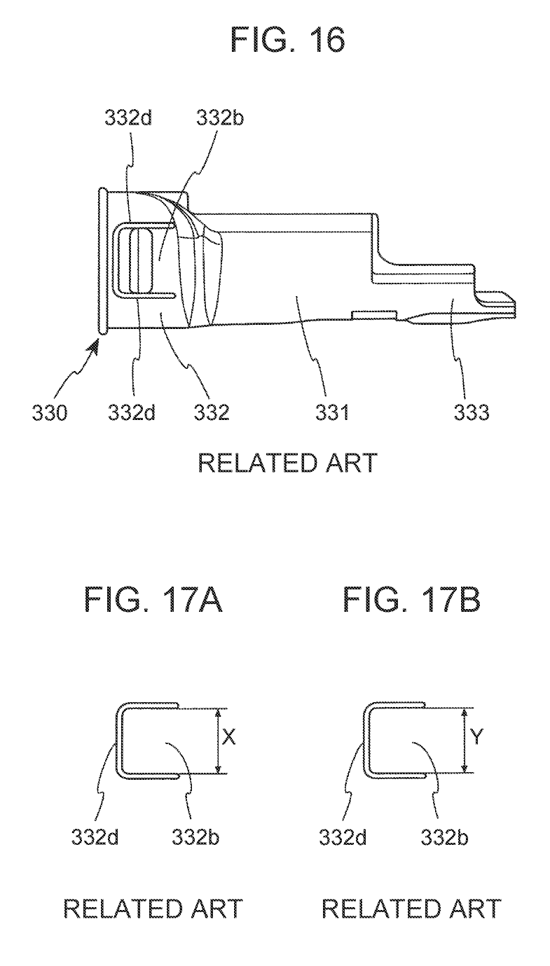

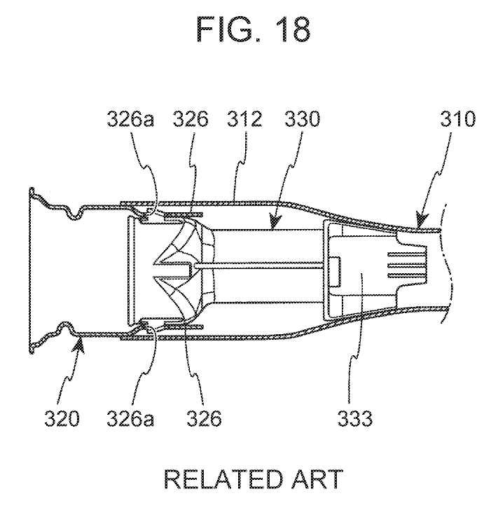

As shown in FIG. 12 and FIG. 13, the inlet part 12 is formed at a leading end portion of the filler pipe 10. The retainer 20 is mounted at the inlet part 12. The part of the filler pipe 10 on the deep side from the inlet part 12 is a main body of the filler pipe 10, and is joined to the fuel tank. An end of a breather pipe 15 is mounted near a root of the inlet part 12. The fuel nozzle holder 30 is mounted to the retainer 20.

Next, the retainer 20 will be described on the basis of FIG. 11. The fuel nozzle holder 30 is mounted to a first attaching portion 22 of the retainer 20. The fuel nozzle holder 30 will be described later. As shown in FIG. 11, a leading end of the retainer 20 has a rim 21 that opens to the vehicle body fueling port into which a fuel nozzle 40 is inserted.

The first attaching portion 22 is formed in a cylindrical shape integrally from the rim 21. When the retainer 20 is inserted into the inlet part 12 of the filler pipe 10, an outer surface of the first attaching portion 22 comes in contact with an inner surface of the inlet part 12 of the filler pipe 10, so that the retainer 20 is stably held.

A spiral retainer thread 25 protruding inward can be formed in the first attaching portion 22. In the case where the rim 21 is covered with a tank cap (not shown), a thread provided in an outer circumference of the tank cap can be fitted into the retainer thread 25 of the first attaching portion 22 to mount the tank cap. In the case where a unit with a flap, instead of a tank cap, is mounted, the retainer 20 can be installed before the unit with a flap to make constant the amount of insertion of the fuel nozzle 40 or the fuel flow direction.

A attaching tilted surface 24 is formed continuously from the first attaching portion 22. The attaching tilted surface 24 is formed so as to continuously connect the first attaching portion 22 and a holding portion 26 to each other. Thus, the fuel nozzle holder 30 can be easily inserted into the retainer 20. Similarly, the fuel nozzle 40 can be inserted smoothly and easily from the retainer 20 to the fuel nozzle holder 30.

The cylindrical holding portion 26 is formed continuously from the attaching tilted surface 24. Engaging holes 26a are formed in the holding portion 26. Engaging pieces 32b to be described later are engaged in the engaging holes 26a. There are two engaging holes 26a formed in the holding portion 26. The two engaging holes 26a are formed on 180 degrees opposite sides in a circumference of the holding portion 26. Thus, the fuel nozzle holder 30 can be stably held by being engaged with the retainer 20 at two positions on the opposite sides in the circumference.

The engaging hole 26a is formed in an oblong shape so as to be longer in the circumferential direction of the retainer 20 than in the longitudinal direction thereof. Thus, a long engaging portion is secured, so that the engaging piece 32b can be firmly engaged in the engaging hole 26a, and the fuel nozzle holder 30 can be stably mounted to the retainer 20.

The length (indicated by F in FIG. 11) of the engaging hole 26a in the circumferential direction is the same as or slightly larger than the length of the engaging piece 32b to be described later. The two engaging holes 26a formed on the opposite sides of the holding portion 26 have different lengths F in the circumferential direction so as to correspond to the sizes of the engaging pieces 32b that are engaged in the engaging holes 26a as will be described later.

An opening 23 having a smaller diameter than the first attaching portion 22 is formed at a leading end of the holding portion 26. When the fuel nozzle is inserted from the rim 21, a main body 31 of the fuel nozzle holder 30 to be described later protrudes from the opening 23 toward the filler pipe 10. A distal end portion 41 of the fuel nozzle 40 can be held by a distal end portion 33 to be described later, and thus the fuel discharge direction can be maintained in a predetermined direction.

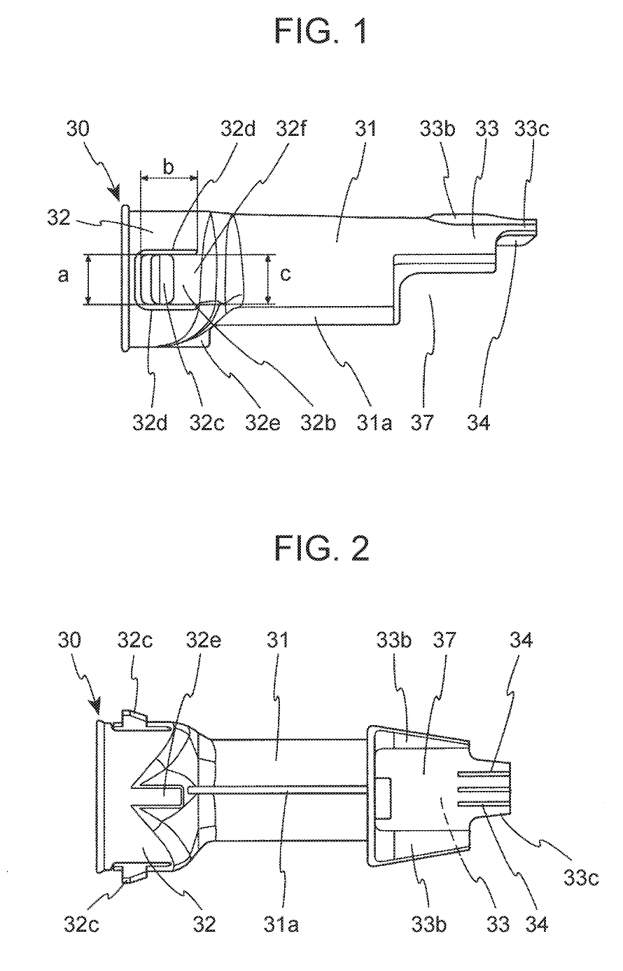

Next, the shape of the fuel nozzle holder 30 will be described on the basis of FIG. 1 to FIG. 9. As shown in FIG. 12 and FIG. 13, the fuel nozzle holder 30 is mounted in the holding portion 26 of the retainer 20. The fuel nozzle holder 30 has a second attaching portion 32 to be mounted to the retainer 20, the main body 31 formed continuously from the second attaching portion 32 and constituting the main body of the fuel nozzle holder 30, and the distal end portion 33 formed on the leading end side of the main body 31.

It is preferable that the retainer 20 and the fuel nozzle holder 30 are made of synthetic resin or metal. The retainer 20 and the fuel nozzle holder 30 made of synthetic resin are easy to manufacture in predetermined shapes. On the other hand, the retainer 20 and the fuel nozzle holder 30 made of metal have high durability as well as high rigidity, so that the retainer 20 can be firmly mounted to the filler pipe 10 and the distal end portion 41 of the fuel nozzle 40 can by reliably held by the fuel nozzle holder 30. Alternatively, the retainer 20 may be made of metal, and the fuel nozzle holder 30 may be made of synthetic resin.

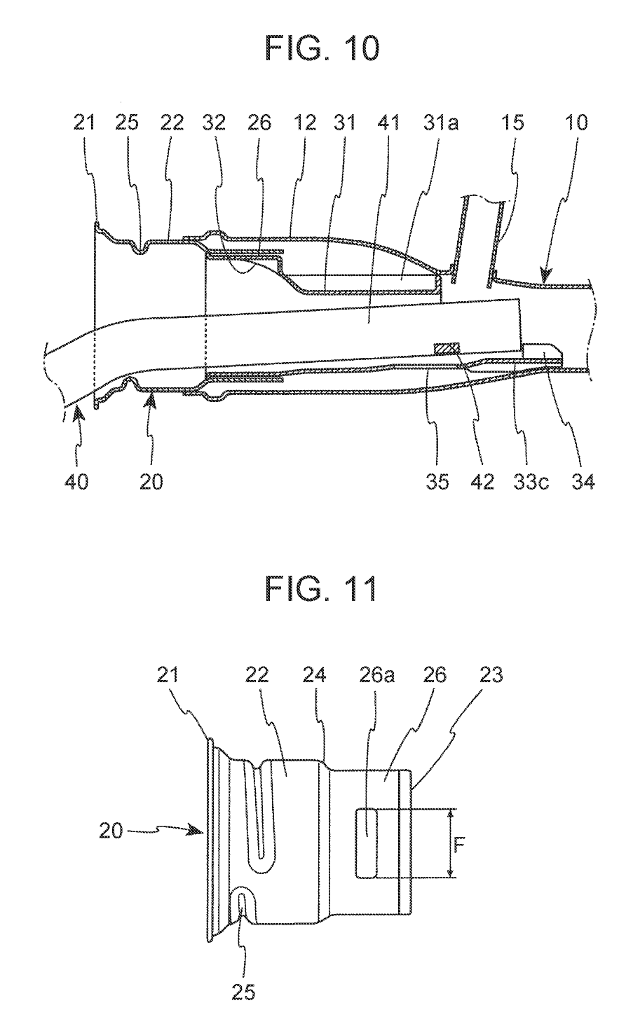

The second attaching portion 32 is inserted on an inner surface of the holding portion 26 and fixed to the inner surface of the holding portion 26. Being mounted in close contact with the inner surface of the holding portion 26, the second attaching portion 32 of the fuel nozzle holder 30 can reliably hold the distal end portion 41 of the fuel nozzle 40 that enters from the holding portion 26 into the fuel nozzle holder 30 as shown in FIG. 10.

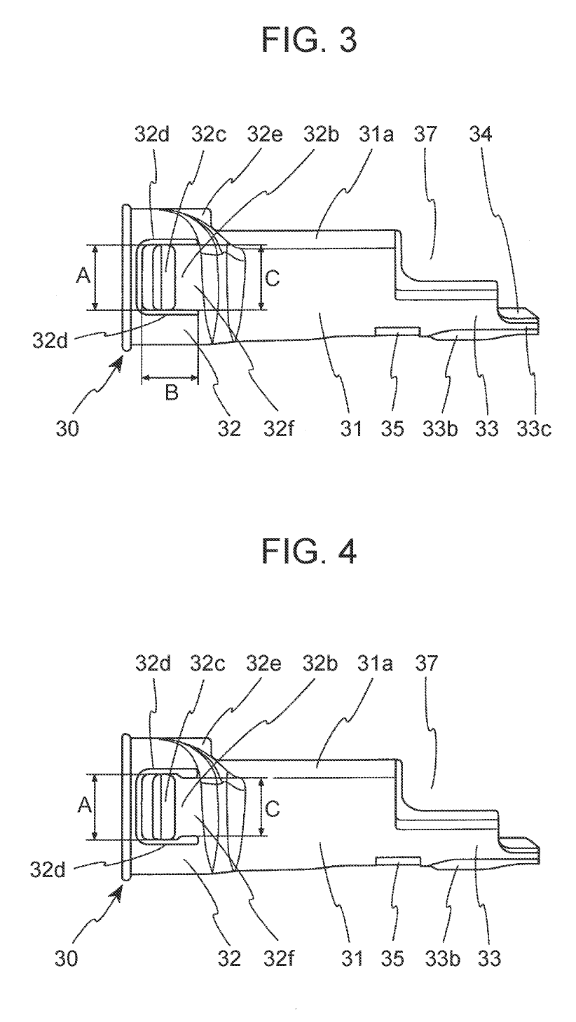

As shown in FIG. 1 and FIG. 3, the engaging pieces 32b are formed on both sides in a side surface of the second attaching portion 32. The engaging pieces 32b each have a protrusion 32c. The fuel nozzle holder 30 is fixed to the retainer 20 as the engaging pieces 32b are engaged in the engaging holes 26a. Thus, it is possible to mount the fuel nozzle holder 30 to the retainer 20 simply by inserting the fuel nozzle holder 30 into the retainer 20, and also to remove the fuel nozzle holder 30 from the retainer 20 for repair etc.

The engaging piece 32b is formed by being surrounded by a U-shaped groove 32d at three sides. The groove 32d is formed by cutting out a wall of the second attaching portion of the fuel nozzle holder 30. Two sides of the three sides of the U-shaped groove 32d extend parallel to the longitudinal direction of the fuel nozzle holder 30, and the ends of the two sides located on the side opposite to the main body 31 are joined together by the other one side that is located on the side opposite to a connecting portion 32f and extends in the circumferential direction of the fuel nozzle holder 30. The lengths of the grooves 32d in the longitudinal direction are indicated by b in FIG. 1 and B in FIG. 3. The lengths of the grooves 32d in the circumferential direction are indicated by a in FIG. 1 and A in FIG. 3.

The engaging piece 32b is integrally joined to the second attaching portion 32 at the connecting portion 32f located on the side of the main body 31. Thus, in the portion of the length of the groove 32d indicated by C, the engaging piece 32b joined to the second attaching portion 32 can deflect easily around the connecting portion 32f joined to the second attaching portion 32, which allows the engaging piece 32b to engage in the engaging hole 26a.

The engaging piece 32b has the protrusion 32c that extends in the circumferential direction and protrudes toward an outer periphery of the second attaching portion 32. Thus, the engaging piece 32b can be firmly engaged in the engaging hole 26a as the protrusion 32c is reliably locked in the engaging hole 26a.

In the first embodiment of the present disclosure shown in FIG. 1 to FIG. 3, the width a in the circumferential direction of the engaging piece 32b formed on the left side of the second attaching portion 32 shown in FIG. 1 is smaller than the width A in the circumferential direction of the engaging piece 32b formed on the right side of the second attaching portion 32 shown in FIG. 3. As to the lengths in the longitudinal direction of the engaging pieces 32b, the length b of the engaging piece 32b formed on the left side shown in FIG. 1 and the length B of the engaging piece 32b formed on the right side shown in FIG. 3 are the same.

As to the dimensions of the connecting portions 32f at which the engaging pieces 32b are joined to the second attaching portion 32, a width c in the circumferential direction of the engaging piece 32b formed on the left side of the second attaching portion 32 shown in FIG. 1 is smaller than a width C in the circumferential direction of the connecting portion 32f of the engaging piece 32b formed on the right side of the second attaching portion 32 shown in FIG. 3.

As described above, the engaging hole 26a formed on the left side of the holding portion 26 in which the engaging piece 32b formed on the left side of the fuel nozzle holder 30 shown in FIG. 1 is locked has a smaller length F in the circumferential direction than the engaging hole 26a formed on the right side of the holding portion 26 in which the engaging piece 32b formed on the right side of the fuel nozzle holder 30 shown in FIG. 3 is locked. Thus, the engaging holes 26a have lengths in the circumferential direction according to the lengths in the circumferential direction of the corresponding protrusions 32c.

Accordingly, if the fuel nozzle holder 30 is inserted into the retainer 20 with the right and left sides of the fuel nozzle holder 30 reversed, the engaging pieces 32b fail to engage in the engaging holes 26a. As shown in FIG. 9, therefore, the engaging pieces 32b of the fuel nozzle holder 30 can be correctly engaged in the corresponding engaging holes 26a, so that the central axis of the fuel nozzle holder 30 coincides with the central axis of the filler pipe 10, and the fuel nozzle holder 30 does not interfere with the filler pipe 10.

In a second embodiment, the width a in the circumferential direction of the engaging piece 32b formed on the left side of the second attaching portion 32 shown in FIG. 1 and the width c in the circumferential direction of the connecting portion 32f at which the engaging piece 32b is joined to the second attaching portion 32 are the same as those of the first embodiment.

As shown in FIG. 4, the width A in the circumferential direction of the engaging piece 32b formed on the right side of the second attaching portion 32 is the same as in the first embodiment, but the shape of the connecting portion 32f at which the engaging piece 32b is joined to the second attaching portion 32 is different from that of the first embodiment. As the second embodiment is different from the first embodiment in the shape of the connecting portion 32f, the different part will be described while description of the other parts will be omitted. As shown in FIG. 4, the connecting portion 32f at which the engaging piece 32b is joined to the second attaching portion 32 has notches formed from the groove 32d in a direction in which the notches face each other.

Accordingly, in the second embodiment, the length C of the connecting portion 32f of the engaging piece 32b formed on the right side is smaller than that of the first embodiment, and is the same as the length c of the connecting portion 32f on the left side. Thus, when inserting the fuel nozzle holder 30 into the retainer 20, one can correctly engage the engaging pieces 32b of the fuel nozzle holder 30 in the corresponding engaging holes 26a. Moreover, this insertion is made easy as the same deflection load can be exerted on the two engaging pieces 32b.

In a third embodiment, the width a in the circumferential direction of the engaging piece 32b formed on the left side of the second attaching portion 32 shown in FIG. 1 and the width c in the circumferential direction of the connecting portion 32f at which the engaging piece 32b is joined to the second attaching portion 32 are the same as those of the first embodiment.

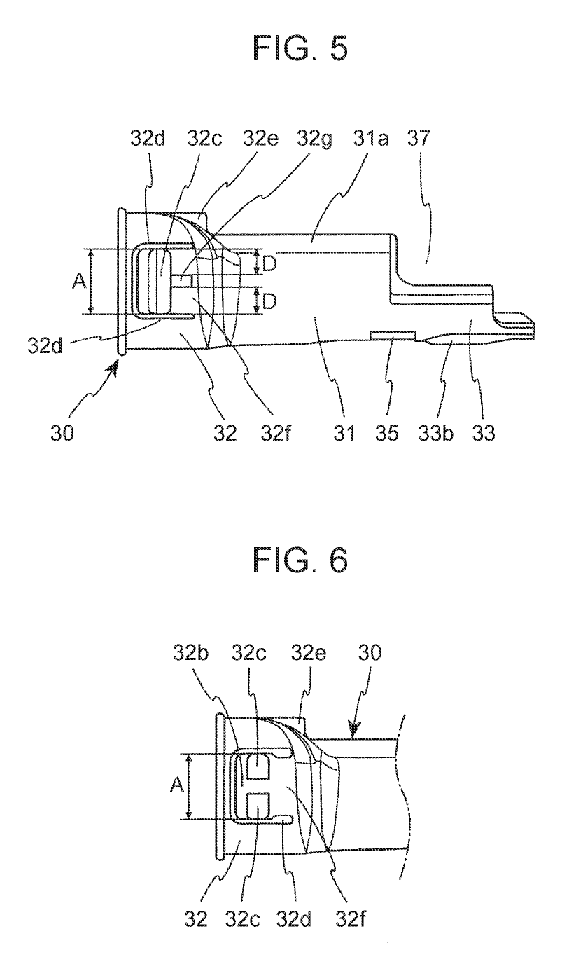

As shown in FIG. 5, the width A in the circumferential direction of the engaging piece 32b formed on the right side of the second attaching portion 32 according to the third embodiment is the same as in the first embodiment. However, the shape of the connecting portion 32f at which the engaging piece 32b is joined to the second attaching portion 32 is different from that of the first embodiment. As the third embodiment is different from the first embodiment in the shape of the connecting portion 32f, the different part will be described while description of the other parts will be omitted. As shown in FIG. 5, the connecting portion 32f at which the engaging piece 32b is joined to the second attaching portion 32 has a connecting portion hole 32g that is a through-hole.

Accordingly, the length of the connecting portion 32f, i.e., the sum of the lengths of the portions except for the connecting portion hole 32g (indicated by D+D in FIG. 5), of the engaging piece 32b formed on the right side is the same as the length c of the connecting portion 32f on the left side. Thus, when inserting the fuel nozzle holder 30 into the retainer 20, one can correctly engage the engaging pieces 32b of the fuel nozzle holder 30 in the corresponding engaging holes 26a. Moreover, this insertion is made easy as the same deflection load can be exerted on the two engaging pieces 32b.

A fourth embodiment is the same as the second embodiment in that the connecting portion 32f at which the engaging piece 32b is joined to the second attaching portion 32 has notches formed from the groove 32d. As the fourth embodiment is different from the second embodiment in the shape of the protrusion 32c formed in the engaging piece 32b, the different part will be described while description of the other parts will be omitted.

As shown in FIG. 6, the protrusion 32c is interrupted at a middle portion and thus divided into two parts. Thus, when inserting the fuel nozzle holder 30 into the retainer 20, this insertion is made easy as the area of the protrusion 32c coming in contact with the retainer 20 can be reduced and the same insertion load can be exerted on the two engaging pieces 32b.

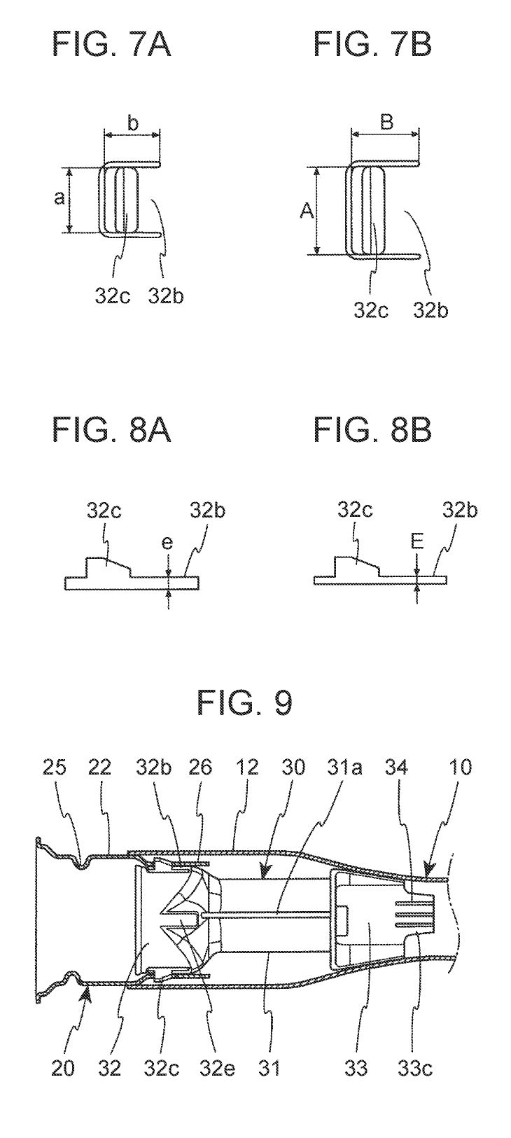

In a fifth embodiment, as in the first embodiment, the width a in the circumferential direction of the engaging piece 32b formed on the left side of the second attaching portion 32 shown in FIG. 7A is smaller than the width A in the circumferential direction of the engaging piece 32b formed on the right side of the second attaching portion 32 shown in FIG. 7B. However, the fifth embodiment is different from the first embodiment in that the length b of the engaging piece 32b formed on the left side of the second attaching portion 32 shown in FIG. 7A is smaller than the length B of the engaging piece 32b formed on the right side of the second attaching portion 32 shown in FIG. 7B. The fifth embodiment is otherwise the same as the first embodiment.

Thus, when inserting the fuel nozzle holder 30 into the retainer 20, one can correctly engage the engaging pieces 32b of the fuel nozzle holder 30 in the corresponding engaging holes 26a. Moreover, this insertion is made easy as the same deflection load can be exerted on the left and right two engaging pieces 32b.

In a sixth embodiment, as in the first embodiment, the width a in the circumferential direction of the engaging piece 32b formed on the left side of the second attaching portion 32 is smaller than the width A in the circumferential direction of the engaging piece 32b formed on the right side of the second attaching portion 32.

However, the sixth embodiment is different from the first embodiment in that a thickness e of the engaging piece 32b formed on the left side of the second attaching portion 32 shown in FIG. 8A is larger than a thickness E of the engaging piece 32b formed on the right side of the second attaching portion 32 shown in FIG. 8B. The sixth embodiment is otherwise the same as the first embodiment.

In the sixth embodiment, as to the thicknesses of the engaging pieces 32b, the thickness e of the engaging piece 32b formed on the left side of the second attaching portion 32 shown in FIG. 8A is larger than the thickness E of the engaging piece 32b formed on the right side of the second attaching portion 32 shown in FIG. 8B. Thus, when inserting the fuel nozzle holder 30 into the retainer 20, one can correctly engage the engaging pieces 32b of the fuel nozzle holder 30 in the corresponding engaging holes 26a. Moreover, this insertion is made easy as the same deflection load can be exerted on the two engaging pieces 32b.

Next, the main body 31 of the fuel nozzle holder 30 will be described on the basis of FIG. 1 to FIG. 3. The shape of the main body 31 is the same throughout the first embodiment to the sixth embodiment of the present disclosure. The main body 31 has a cylindrical shape smaller in diameter than the second attaching portion 32, and the main body 31 and the second attaching portion 32 are formed integrally and continuously through a slope. A rib 32e is formed on an outer face of the slope. A rib 31a is formed in an upper part (an upper part in FIG. 3; a lower part in FIG. 1) of the main body 31. Thus, the fuel nozzle holder 30 can be stably mounted to the retainer 20 as shown in FIG. 9.

A holding portion upper-side opening 37 that is left open is formed in an upper surface (an upper surface in FIG. 3; a lower surface in FIG. 1) on the leading end side of the main body 31 of the fuel nozzle holder 30. As the upper surface of the fuel nozzle holder 30 is left open by the holding portion upper-side opening 37 formed therein, it is possible to lock the distal end portion 41 of the fuel nozzle 40 by a fuel nozzle engaging piece 34 to be described later, as well as to prevent the distal end portion 41 of the fuel nozzle 40 from being caught by the fuel nozzle holder 30. Thus, the fuel nozzle 40 is easy to insert and extract.

The distal end portion 33 is formed on the leading end side of the main body 31. The distal end portion 33 has a holding piece 33c that holds a lower surface of the distal end portion 41 of the fuel nozzle 40, and the fuel nozzle engaging piece 34 that is formed in the holding piece 33c and locks the distal end portion 41 of the fuel nozzle 40. As shown in FIG. 9, the distal end portion 33 is inserted to the vicinity of the main body of the filler pipe 10. A distal end portion outer rib 33b is formed on the outer side of the distal end portion 33, and can come in contact with an inner surface of the filler pipe 10.

The holding piece 33c is formed at a lower edge (an upper edge in FIG. 3; a lower edge in FIG. 1) of the distal end portion 33. As shown in FIG. 10, the holding piece 33c can lock the distal end portion 41 of the fuel nozzle 40 by the fuel nozzle engaging piece 34 while holding the distal end portion 41 of the fuel nozzle 40, and can stop the distal end portion 41 of the fuel nozzle 40 at a predetermined position by preventing the distal end portion 41 of the fuel nozzle 40 from entering too deep into the filler pipe 10 (toward the fuel tank) beyond the fuel nozzle engaging piece 34. Thus, the distal end portion 41 of the fuel nozzle 40 is stabilized, which allows fueling with a stable fuel flow from the fuel nozzle into the filler pipe 10.

As shown in FIG. 10, an automatic stop sensor hole 35 is formed in the distal end portion 33 of the fuel nozzle holder 30, at a portion corresponding to an automatic stop sensor that is mounted on the distal end portion 41 of the fuel nozzle 40. Thus, when the fuel tank is filled up during fueling by the fuel nozzle, the automatic stop sensor can be activated by reliably detecting the fuel through the automatic stop sensor hole 35, so that false detection can be prevented.

Next, the action of inserting the distal end portion 41 of the fuel nozzle 40 from the rim 21 of the retainer 20 will be described. As shown in FIG. 10, when the distal end portion 41 of the fuel nozzle 40 is inserted from the rim 21 of the retainer 20, the distal end portion passes through the first attaching portion 22 of the retainer 20 and then passes through the second attaching portion 32 and the main body 31 of the fuel nozzle holder 30 before reaching the distal end portion 33 of the fuel nozzle holder 30.

Meanwhile, as shown in FIG. 9, the fuel nozzle holder 30 is positioned with the central axis thereof coinciding with the central axis of the filler pipe 10 as indicated by the arrow in FIG. 9, so that the fuel released from the distal end portion 41 of the fuel nozzle 40 flows smoothly through the filler pipe 10, and the fuel does not flow back.

As the distal end portion 41 of the fuel nozzle 40 is prevented by the fuel nozzle engaging piece 34 from entering too deep into the filler pipe 10, the fuel nozzle 40 is easy to insert and extract. Moreover, as the upper surface of the fuel nozzle holder 30 is left open as the holding portion upper-side opening 37, the distal end portion 41 of the fuel nozzle 40 is not caught by the fuel nozzle holder 30.

In the first to sixth embodiments, the second attaching portion 32 has the two engaging pieces 32b on both sides in the side surface. Alternatively, the second attaching portion 32 may have three of more engaging pieces, for example, and these engaging pieces may be disposed so that a figure formed by connecting the adjacent engaging pieces is point-symmetric with respect to the center of a circle defined by a cross-section of the second attaching portion 32. If the second attaching portion has three or more engaging pieces, one engaging piece should be larger than the other engaging pieces in the maximum value of the width in the circumferential direction of the second attaching portion.

This is because, if the second attaching portion has three or more engaging pieces, the fuel nozzle holder 30 may be incorrectly installed in the retainer 20 at a position reached by turning a predetermined angle in the circumferential direction of the second attaching portion. However, if one engaging piece is larger than the other engaging pieces in the maximum value of the width in the circumferential direction of the second attaching portion, the engaging pieces can be correctly engaged in the corresponding engaging holes.

In the first to sixth embodiments, the engaging piece 32b is surrounded by the U-shaped groove 32d at three sides. However, the shape of the groove 32d is not limited to a U-shape, as long as the engaging piece 32b is separated by the groove 32d from the second attaching portion 32 at the portion other than the connecting portion 32f For example, the groove 32d may have a V-shape or an arc shape.

What is claimed is:

1. A filler pipe in which a retainer that holds a fuel nozzle holder is mounted, wherein
the retainer includes:
a first attaching portion mounted at an inlet part of the filler pipe;
an opening located at a first end of the retainer, the first end being closer to a center of the filler pipe in a longitudinal direction than a second end of the retainer; and
a holding portion having engaging holes,
the fuel nozzle holder includes:
a second attaching portion having a cylindrical shape and mounted to the retainer, the second attaching portion includes two engaging pieces; and
a main body extending from the second attaching portion toward the center of the filler pipe in the longitudinal direction of the filler pipe,
the two engaging pieces are located on opposite sides in a circumference of the second attaching portion,
the engaging pieces are each surrounded by a U-shaped groove at three sides and joined to the second attaching portion at a connecting portion located on a main body side, and the two engaging pieces are different from each other in terms of a maximum value of a length in a circumferential direction of the second attaching portion, and
the fuel nozzle holder is fixed to the retainer by engaging the engaging pieces in the engaging holes.

2. The filler pipe according to claim 1, wherein
the engaging pieces are different from each other in terms of a length in the circumferential direction at a leading end located on a side opposite to the main body in a longitudinal direction of the fuel nozzle holder, and
the engaging pieces are the same in terms of a length of the connecting portion in the circumferential direction.

3. The filler pipe according to claim 2, wherein
the connecting portion of one engaging piece joined to the second attaching portion has a notch or a through-hole, and is the same as the connecting portion of the other engaging piece in terms of the length in the circumferential direction.

4. The filler pipe according to claim 1, wherein
the engaging pieces are different from each other in terms of a length in the circumferential direction at a leading end located on a side opposite to the main body in a longitudinal direction of the fuel nozzle holder, and
one engaging piece of the engaging pieces that is longer in the circumferential direction is longer in the longitudinal direction of the fuel nozzle holder than the other engaging piece that is shorter in the circumferential direction.

5. The filler pipe according to claim 1, wherein
the engaging pieces are different from each other in terms of a length in the circumferential direction at a leading end located on a side opposite to the main body in a longitudinal direction of the fuel nozzle holder, and
one engaging piece of the engaging pieces that is longer in the circumferential direction is thicker in a radial direction of the second attaching portion than the other engaging piece.

6. The filler pipe according to claim 1, wherein the engaging pieces each have a protrusion that has a longer side along the circumferential direction as seen from a radial direction of the second attaching portion and protrudes toward an outer periphery of the second attaching portion.

7. The filler pipe according to claim 1, wherein the fuel nozzle holder includes a distal end portion in the main body on the side closer to the center of the filler pipe in the longitudinal direction and holds a distal end portion of a fuel nozzle.

8. The filler pipe according to claim 1, wherein the retainer and the fuel nozzle holder are made of synthetic resin or metal.

9. The filler pipe according to claim 6, wherein the engaging pieces are held in the engaging holes as the protrusions are inserted into the engaging holes.

10. The filler pipe according to claim 9, wherein lengths of the engaging holes in the circumferential direction of the second attaching portion are equal to lengths of the corresponding protrusions in the circumferential direction of the second attaching portion.

11. A filler pipe in which a retainer that holds a fuel nozzle holder is mounted, wherein
the retainer includes:
a first attaching portion mounted at an inlet part of the filler pipe; an opening located at a first end of the retainer, the first end being closer to a center of the filler pipe in a longitudinal direction of the filler pipe than a second end of the retainer; and
a holding portion having engaging holes,
the fuel nozzle holder includes:
a second attaching portion having a cylindrical shape and mounted to the retainer; and
a main body extending from the second attaching portion toward the center of the filler pipe in the longitudinal direction of the filler pipe,
the second attaching portion includes a plurality of engaging pieces,
the engaging pieces are disposed so that a figure formed by connecting the engaging pieces adjacent to each other in a circumference of the second attaching portion is point-symmetric with respect to a center of a circle defined by a cross-section of the second attaching portion,
the engaging pieces each have a protrusion that protrudes toward an outer periphery of the second attaching portion,
the engaging pieces are each joined to the second attaching portion at a connecting portion provided on a main body side and separated from the second attaching portion by a groove at both ends in a circumferential direction of the second attaching portion and at an end located on a side opposite to the main body in the longitudinal direction of the fuel nozzle holder,
at least one of the engaging pieces is different from the other engaging pieces in terms of the shape of the protrusion, and
the fuel nozzle holder is fixed to the retainer as the protrusions are inserted into the engaging holes.

12. The filler pipe according to claim 11, wherein a maximum value of a length of one of the protrusions in the circumferential direction of the second attaching portion is larger than maximum values of lengths of other protrusions in the circumferential direction of the second attaching portion.

13. The filler pipe according to claim 11, wherein lengths of the engaging holes in the circumferential direction of the second attaching portion are equal to the lengths of the corresponding protrusions in the circumferential direction of the second attaching portion.

14. The filler pipe according to claim 11, wherein all the engaging pieces are the same in terms of a length of the connecting portion in the circumferential direction of the second attaching portion.

15. A vehicle fuel filler port structure comprising:
a filler pipe;
a retainer including:
a first attaching portion mounted at an inlet part of the filler pipe;
an opening located at a first end of the retainer, the first end being closer to a center of the filler pipe in a longitudinal direction of the filler pipe than a second end of the retainer; and
a holding portion having engaging holes; and
a fuel nozzle holder including:
a second attaching portion having a cylindrical shape and mounted to the retainer; and
a main body extending from the second attaching portion toward the center of the filler pipe in the longitudinal direction of the filler pipe, wherein
the second attaching portion includes a plurality of engaging pieces,
the engaging pieces are disposed so that a figure formed by connecting the engaging pieces adjacent to each other in a circumference of the second attaching portion is point-symmetric with respect to a center of a circle defined by a cross-section of the second attaching portion,
the engaging pieces each have a protrusion that protrudes toward an outer periphery of the second attaching portion,
the engaging pieces are each joined to the second attaching portion at a connecting portion provided on a main body side and separated from the second attaching portion by a groove at both ends in a circumferential direction of the second attaching portion and at an end located on a side opposite to the main body,
at least one of the engaging pieces is different from the other engaging pieces in terms of the shape of the protrusion, and
the fuel nozzle holder is fixed to the retainer as the protrusions are inserted into the engaging holes.
